(19) United States
(12) Patent Application Publication
(10) Pub. No.: US 2025/0307376 A1
(43) Pub. Date: Oct. 2, 2025

(54) AUTHENTICATION SYSTEM AND METHOD FOR VERIFYING AUTHENTIC CREATION OF DIGITAL CONTENT

(71) Applicant: WordPath, Inc, New York, NY (US)

(72) Inventors: Gavin Brown, New York, NY (US); Frederick Lindenhovius, Brooklyn, NY (US); Camille Socolof, Port Washington, NY (US); Daniel Kossow, Alameda, CA (US)

(21) Appl. No.: 19/084,827

(22) Filed: Mar. 20, 2025

Related U.S. Application Data
(60) Provisional application No. 63/570,847, filed on Mar. 28, 2024.

(51) Int. Cl. G06F 21/44

(52) U.S. Cl. CPC G06F 21/44

(57) ABSTRACT

An authentication system for verifying creation of digital content includes a machine learning classifier configured to analyze data points related to a content creation process, a programmatic rules-based analysis component configured to apply predefined criteria to the data points, and a human-viewable replay component configured to provide a visual representation of the content creation process. The authentication system is configured to determine whether the digital content was created by a human or generated by artificial intelligence (AI) based on outputs from the machine learning classifier, the programmatic rules-based analysis component, and the human-viewable replay component. The data points may include keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data.

### CROSS-REFERENCE TO RELATED APPLICATIONS

This application is a Utility Patent application claiming priority to U.S. Provisional Patent Application Ser. No. 63/570,847, filed on Mar. 28, 2024, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants make no claim to any trademarks referenced.

### BACKGROUND OF THE INVENTION

### 1) Field of the Invention

The present disclosure relates to authentication systems for verifying digital content, and more particularly to an authentication system that analyzes content creation processes to distinguish between human-generated and AI-generated digital content.

### 2) Description of Related Art

In the digital age, content creation has become a ubiquitous activity, spanning a wide range of formats including text, images, audio, and video. This content is often created and entered into computing systems through various input methods, such as typing, voice input, touch screen gestures, and digital drawing tools. The process of content creation involves a multitude of interactions with the computing system, each of which generates data that can be analyzed to gain insights into the content creation process.

The rise of AI-generated educational materials also creates a need for effective mechanisms to verify their origin and accuracy. As these resources become more prevalent, ensuring that students receive high-quality, credible information becomes paramount. Traditional methods of content verification often rely on superficial analysis of the final product, which may not adequately capture the nuances that differentiate human thought processes and creativity from AI-generated output.

Current authentication systems often face limitations in their ability to adapt to diverse types of digital content and evolving AI technologies. Many are designed with a narrow focus, limited to specific content types or formats, which may not adequately address the broad spectrum of digital creations in today's landscape. Additionally, these systems may struggle to provide clear, understandable explanations for their determinations, potentially undermining trust and confidence in the verification process.

As the line between human and AI-generated content continues to blur, there is an increasing demand for comprehensive, adaptable, and transparent authentication methods. Such systems could have wide-ranging applications, from upholding academic integrity to supporting copyright protection and fostering appreciation for human creativity in an increasingly AI-driven world.

Sophisticated generative artificial intelligence (AI) technologies have started a new era of content creation, enabling machines to produce text, images, audio, and videos that closely mimic human output. This technological leap forward, while beneficial in many respects, introduces a complex challenge in distinguishing between content genuinely created by humans and content generated by AI and re-created or re-input into a system by a human. The ability to accurately identify the source of digital content is becoming increasingly critical, not only for upholding copyright and intellectual property rights but also for ensuring the integrity of academic work, human-created art, and the effectiveness of educational programs.

In the realm of education, the distinction between human and AI-generated content is of paramount importance. The rise of AI-driven content creation tools presents new challenges for educators and institutions in assessing the authenticity of students' work and safeguarding against plagiarism. Moreover, the rise of AI-generated educational materials necessitates an effective mechanism to verify their origin and accuracy, ensuring that students receive high-quality, credible information.

Current methods for determining the origin of digital content primarily rely on analyzing the final product, often leading to inaccuracies and overlooking the intricacies of human creativity. These methods are increasingly insufficient in the face of rapidly advancing AI technologies capable of producing highly sophisticated and human-like content. Furthermore, traditional approaches do not address the unique challenges posed within educational settings, where the verification of content authenticity plays a crucial role in the learning process. The absence of a reliable and adaptable solution hinders the enforcement of copyright laws, compromises the trustworthiness of digital content, and undermines the academic integrity of educational environments.

Addressing this challenge requires an approach that goes beyond conventional analysis, capturing the subtle distinctions between human and AI-generated content. It requires the development of a method that can analyze the content creation process itself, leveraging advanced technologies to discern the genuine hallmarks of human creativity from the pattern characteristics of AI generation.

### BRIEF SUMMARY OF THE INVENTION

The present disclosure is directed to a method for analyzing digital content creation. The method includes collecting a variety of data points related to the content creation process, utilizing a machine learning classifier to analyze the collected data and distinguish between human and AI-generated content, applying a programmatic rules-based analysis to the collected data, and providing a human-viewable replay of the content creation process. The method uses the authentication system as described herein.

A variety of data points used in the analysis may include keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data. The keystroke dynamics may include timing, rhythm, and pressure of the keystrokes. The syntax and style analysis may include examination of language use, grammar, stylistic choices, and narrative structures. The error patterns and corrections may include tracking the occurrence, type, and correction of errors during the content creation process. The behavioral data may include mouse movements, scrolling patterns, and navigation behaviors during the research and drafting phases. The machine learning classifier may utilize a corpus of data comparing human-generated work and human recreation of AI-generated work to train the system.

According to another aspect of the present disclosure, the authentication system for analyzing digital content creation includes a data collection module for collecting a variety of data points related to the content creation process, a machine learning classifier module configured to analyze the collected data and distinguish between human and AI-generated content, a rules-based analysis module configured to apply a predefined set of criteria to the collected data, and a replay module configured to provide a human-viewable replay of the content creation process.

According to other aspects of the present disclosure, the data collection module may be further configured to collect data on keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data. The data on keystroke dynamics may include data on the timing, rhythm, and pressure of the keystrokes. The data on syntax and style analysis may include data on language use, grammar, stylistic choices, and narrative structures. The machine learning classifier may be further configured to utilize a corpus of data comparing human-generated work and human recreation of AI-generated work to train the system. The rules-based analysis module may be further configured to apply a predefined set of criteria to the collected data. The replay module may be further configured to provide a visual and interactive replay of the content creation process.

According to yet another aspect of the present disclosure, the method for verifying the authenticity of digital content includes monitoring a variety of interactions during the content creation process, collecting data related to the content creation process, utilizing a machine learning classifier to analyze the collected data and distinguish between human and AI-generated content, applying a programmatic rules-based analysis to the collected data, and providing a human-viewable replay of the content creation process.

According to other aspects of the present disclosure, the variety of interactions may include keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data. The keystroke dynamics may include timing, rhythm, and pressure of the keystrokes. The syntax and style analysis may include examination of language use, grammar, stylistic choices, and narrative structures. The machine learning classifier may utilize a corpus of data comparing human-generated work and human recreation of AI-generated work to train the system. The human-viewable replay of the content creation process may be provided in a visual and interactive format. The authentication system can take information and process it to create the output classification and/or confidence rating.

The authentication system can use Artificial Intelligence (AI) technologies have also been developed to generate digital content. These AI technologies can produce content that closely mimics human output, making it increasingly difficult to distinguish between content created by humans and content generated by AI. AI-generated content can be re-entered into a computing system by a human, further complicating the task of determining the original source of the content.

The authentication system uses machine learning, a subset of AI, involves the use of algorithms and statistical models to perform tasks without explicit instructions. Machine learning classifiers are a type of machine learning model that can be trained to distinguish between different categories of data. These classifiers can be trained using a corpus of data, which is a large and structured set of texts or other data.

The authentication system can use programmatic rules-based analysis involving the application of a predefined set of criteria or rules to the data. The rules can be designed to identify specific patterns or characteristics in the data. The process of content creation can also be analyzed through a replay of the content creation process. This replay can provide a visual and interactive representation of the content creation process, allowing for a detailed examination of the interactions that occurred during the creation of the content.

The authentication system uses keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data are all examples of data points that can be collected and analyzed during the content creation process. Each of these data points can provide valuable insights into the process of content creation and can contribute to the task of distinguishing between human and AI-generated content.

The authentication system has applications in educational settings, whereby the system is used to assess the authenticity of student work. In professional environments, the system may help verify the originality of documents or creative works.

The authentication system may provide a confidence score indicating the likelihood that the content was created by a human. This score may be expressed as a percentage, with higher percentages suggesting a higher probability of human authorship. The authentication system may be designed to be adaptable and scalable, capable of analyzing various types of digital content including text, images, audio, and video. In some cases, the system may evolve alongside advancements in AI technology to maintain its effectiveness in distinguishing between human and AI-generated content. The authentication system may include a machine learning classifier component that plays a crucial role in analyzing various data points related to content creation. This classifier may be trained to distinguish between human-generated content and AI-generated content based on patterns and characteristics observed during the content creation process.

The machine learning classifier may analyze data such as keystroke dynamics, syntax and style, error patterns, revision history, and behavioral data to make its determinations. The classifier may be designed to recognize subtle differences in these data points that typically differentiate human-created content from AI-generated content. The machine learning classifier may be trained using a corpus of data that compares human-generated work with human recreations of AI-generated work. This training approach may allow the classifier to learn the nuanced differences between authentic human-created content and content that mimics AI-generated work but is actually created by humans. By using this comparative dataset, the classifier may develop a more refined ability to distinguish between genuine human-created content and sophisticated AI-generated content. The machine learning classifier may employ various algorithms and techniques to process and analyze the input data. These may include, but are not limited to, neural networks, decision trees, support vector machines, or ensemble methods. The choice of algorithm may depend on the specific types of data being analyzed and the desired performance characteristics of the classifier.

The classifier may output a probability or confidence score indicating the likelihood that the analyzed content was created by a human. This score may be used in conjunction with other components of the authentication system to provide a comprehensive assessment of content authenticity. The machine learning classifier may be designed to adapt and improve its performance over time. As new data becomes available and as AI content generation techniques evolve, the classifier may be retrained or fine-tuned to maintain its effectiveness in distinguishing between human and AI-generated content. In some implementations, the machine learning classifier may employ various algorithms and techniques to process and analyze the input data. These may include, but are not limited to, neural networks, decision trees, support vector machines, or ensemble methods. The choice of algorithm may depend on the specific types of data being analyzed and the desired performance characteristics of the classifier.

The foregoing general description of the illustrative embodiments and the following detailed description thereof are merely exemplary aspects of the teachings of this disclosure and are not restrictive.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

Corresponding reference characters indicate corresponding parts throughout the several views. The exemplifications set out herein illustrate embodiments of the invention and such exemplifications are not to be construed as limiting the scope of the invention in any manner.

FIG. 1 shows a block diagram of the authentication system according to the present invention; and

FIG. 2 is a flowchart showing a method for using the authentication system of FIG. 1.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

In the present disclosure, the machine learning classifier module is a module which implements an application for the machine learning classifier. Likewise, the programmatic rules-based analysis module is a module which implements an application for programmatic rules-based analysis and the human-viewable replay module is a module which implements an application for human-viewable replay.

In this disclosure, analyzing human content is the term applied to performing analysis on the content which presumed to be human derived, but is the content which the source is to be determined by the authentication system.

The authentication system is comprised of three primary components or modules: a machine learning classifier, programmatic rules-based analysis, and a human-viewable replay of the content creation process. These modules collectively analyze a wide array of data points related to the content creation process, including but not limited to:
a. Keystroke Dynamics: Timing, rhythm, and pressure of key presses, reflecting unique human typing patterns versus the uniform input often seen in AI-generated content.
b. Syntax and Style Analysis: Examination of language use, grammar, stylistic choices, and narrative structures, distinguishing nuanced human writing from AI patterns.
c. Error Patterns and Corrections: Tracking the occurrence, type, and correction of errors, indicative of the iterative and sometimes imperfect human creative process.
d. Content Revision History: Analysis of changes and edits over time, providing insight into the human thought process and decision-making in content creation.
e. Behavioral Data: Including mouse movements, scrolling patterns, and navigation behaviors during the research and drafting phases, indicative of human interaction.
f. Content Creation Timeline: Evaluation of the pacing and distribution of content creation activities, characteristic of the varied intensity of human engagement.
g. Gestures and Touch Interactions: Analysis of touch screen gestures, such as swipes, taps, and zooms, which can reflect the direct and intuitive interaction of a human user.
h. Brushstrokes and Drawing Patterns: For graphical content, the analysis of brushstroke speed, pressure, and sequence, offering insights into the artist's method and style, distinguishing between human artistry and AI generation.
i. Voice and Audio Analysis: For content created through voice inputs, examining adaptive learning variations, hesitations, and natural speech patterns, contrasted with the more consistent output of speech generation AI.
j. Physical Interaction with Devices: Monitoring of hardware interactions, such as tablet pen usage, keyboard shortcuts, and other device-specific inputs, revealing the hands-on approach of human creators.
k. Eye Tracking and Gaze Patterns: When available, analyzing where and how long a creator looks at specific parts of the screen during the creation process, indicating focus areas and thought progression.
l. Biometric Data: Where applicable and ethical, collecting data on heart rate, body language, or facial expressions during creation, which may offer additional context about the creator's emotional state and engagement.

Each of these data points contributes to a robust analysis of digital content, allowing for an accurate determination of its origin. The machine learning classifier uses the collected data to train models that can distinguish between human and AI-generated content, adapting over time to evolving patterns. A corpus of data comparing human-generated work and human recreation of AI-generated work is used to train the system to correctly differentiate between the two. Programmatic rules-based analysis applies a predefined set of criteria to analyze content creation data, providing a transparent and understandable layer of analysis. Human-viewable replay offers stakeholders the ability to review the content creation process, providing a visual and interactive means to assess the authenticity of digital works.

The analysis tools of the authentication system provide a confidence score that shows how likely it is that digital content was made by a human. This score is given as a percentage. A high percentage means the content is very likely to be human-created, while a low percentage suggests it might be AI-generated. This way, users can see clearly how confident the system is in its assessment, helping them make informed decisions based on the specific level of confidence they need for verifying content authenticity.

The present disclosure pertains to the field of digital content analysis, specifically to systems and methods for distinguishing between content created by humans and content generated by artificial intelligence (AI). In some aspects, the disclosure provides a comprehensive approach to analyze the process of digital content creation, leveraging a variety of data points collected during the creation process. This approach may offer a more nuanced and accurate determination of the origin of digital content, addressing the challenge of distinguishing between human and AI-generated content.

The method for analyzing digital content creation may involve collecting a variety of data points related to the content creation process, utilizing a machine learning classifier to analyze the collected data, applying a programmatic rules-based analysis to the collected data, and providing a human-viewable replay of the content creation process. The variety of data points may include, but are not limited to, keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data. The machine learning classifier may utilize a corpus of data comparing human-generated work and human recreation of AI-generated work to train the system. This approach may allow the system to adapt over time to evolving patterns in content creation, enhancing its ability to accurately distinguish between human and AI-generated content. A system for analyzing digital content creation may include a data collection module, a machine learning classifier, a rules-based analysis module, and a replay module. These modules may work together to collect and analyze a wide array of data points related to the content creation process, providing a robust and comprehensive analysis of digital content.

By analyzing the process of content creation rather than just the final product, the method and authentication system reduces the rate of false positives and enhance the verification of content authenticity. Furthermore, the method and system may be adaptable and scalable, capable of analyzing various types of digital content and evolving alongside advancements in AI technology. This flexibility may ensure the long-term relevance and effectiveness of the method and system in verifying the authenticity of digital content.

The method for analyzing digital content creation may involve collecting a variety of data points related to the content creation process. These data points may provide a comprehensive view of the interactions that occur during the creation of digital content. For instance, keystroke dynamics, such as the timing, rhythm, and pressure of the keystrokes, may be collected to reflect the distinctive human typing patterns. Syntax and style analysis may involve the examination of language use, grammar, stylistic choices, and narrative structures, providing insights into the nuanced human writing patterns. Error patterns and corrections may be tracked to capture the iterative and sometimes imperfect human creative process. Content revision history, which includes changes and edits over time, may offer a glimpse into the human thought process and decision-making in content creation.

Behavioral data, such as mouse movements, scrolling patterns, and navigation behaviors during the research and drafting phases, may be collected to indicate human interaction with the digital content. The content creation timeline, which evaluates the pacing and distribution of content creation activities, may reflect the varied intensity of human engagement. Gestures and touch interactions, such as swipes, taps, and zooms on a touch screen, may be analyzed to reflect the direct and intuitive interaction of a human user. For graphical content, brushstrokes and drawing patterns, including brushstroke speed, pressure, and sequence, may be analyzed to offer insights into the artist's method and style. Voice and audio analysis may be performed for content created through voice inputs, examining pitch variations, hesitations, and natural speech patterns.

Physical interaction with devices, such as tablet pen usage, keyboard shortcuts, and other device-specific inputs, may be monitored to reveal the hands-on approach of human creators. Eye tracking and gaze patterns, when available, may be analyzed to determine where and how long a creator looks at specific parts of the screen during the creation process, indicating focus areas and thought progression. Biometric data, where applicable and ethical, may be collected to provide additional context about the creator's emotional state and engagement. This data may include heart rate, body language, or facial expressions during the content creation process.

A machine learning classifier may be utilized to analyze the collected data and distinguish between human and AI-generated content. The machine learning classifier may adapt over time to evolving patterns in content creation, enhancing its ability to accurately distinguish between human and AI-generated content. The machine learning classifier may utilize a corpus of data comparing human-generated work and human recreation of AI-generated work to train the system. This approach may allow the system to learn from past examples and improve its performance over time.

The programmatic rules-based analysis may be applied to the collected data by a programmatic rules-based analysis module. This analysis may involve the application of a predefined set of criteria or rules to the data. The rules may be designed to identify specific patterns or characteristics in the data that are indicative of human or AI-generated content.

The human-viewable replay of the content creation process may be provided by a human-viewable replay module. This replay may offer a visual and interactive representation of the content creation process, allowing for a detailed examination of the interactions that occurred during the creation of the content. This feature may provide stakeholders with the ability to review the content creation process, offering a transparent and understandable means to assess the authenticity of digital works.

The machine learning classifier may be a central module of the system for analyzing digital content creation. Analysis is based on a variety of data points collected during the content creation process, such as keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data.

The machine learning classifier may utilize a corpus of data comparing human-generated work and human recreation of AI-generated work to train the system. This corpus of data may serve as a training set for the classifier, providing examples of both human and AI-generated content. The classifier may learn from these examples, developing a model that can accurately differentiate between human and AI-generated content. Over time, as more data is collected and analyzed, the classifier may adapt and refine its model, improving its ability to distinguish between human and AI-generated content.

The data collection module in the system for analyzing digital content creation may be further configured to collect a wide array of data points related to the content creation process. These data points may provide a comprehensive view of the interactions that occur during the creation of digital content. For instance, the data on keystroke dynamics may include data on the timing, rhythm, and pressure of the keystrokes. The data on syntax and style analysis may include data on language use, grammar, stylistic choices, and narrative structures. The data on error patterns and corrections may include data on the occurrence, type, and correction of errors during the content creation process. The data on behavioral data may include data on mouse movements, scrolling patterns, and navigation behaviors during the research and drafting phases.

The machine learning classifier in the system for analyzing digital content creation may be further configured to utilize a corpus of data comparing human-generated work and human recreation of AI-generated work to train the system. This corpus of data may serve as a training set for the classifier, providing examples of both human and AI-generated content. The classifier may learn from these examples, developing a model that can accurately differentiate between human and AI-generated content. Over time, as more data is collected and analyzed, the classifier may adapt and refine its model, improving its ability to distinguish between human and AI-generated content.

The programmatic rules-based analysis may be applied to the collected data. This analysis may involve the application of a predefined set of criteria or rules to the data. These rules may be designed to identify specific patterns or characteristics in the data that are indicative of human or AI-generated content. For instance, the rules may be based on the analysis of keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data. The application of these rules to the collected data may provide a transparent and understandable layer of analysis, complementing the machine learning classifier's analysis. The rules-based analysis module in the system for analyzing digital content creation may be further configured to apply a predefined set of criteria to the collected data. This module may apply the rules to the data collected by the data collection module, providing an additional layer of analysis to the system. The rules applied by the rules-based analysis module may be predefined and may be designed to identify specific patterns or characteristics in the data that are indicative of human or AI-generated content. The application of these rules to the collected data may provide a transparent and understandable layer of analysis, complementing the machine learning classifier's analysis. This approach may enhance the system's ability to accurately distinguish between human and AI-generated content.

The human-viewable replay of the content creation process may be provided. This replay may offer a visual and interactive representation of the content creation process, allowing for a detailed examination of the interactions that occurred during the creation of the content. The replay may include a timeline of the content creation process, showing the sequence of actions taken by the creator. It may also include visual indicators of the different types of data points collected during the content creation process, such as keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data. This feature may provide stakeholders with the ability to review the content creation process, offering a transparent and understandable means to assess the authenticity of digital works. The replay module in the system for analyzing digital content creation may be further configured to provide a visual and interactive replay of the content creation process. This module may generate a replay of the content creation process based on the data collected by the data collection module. The replay may be presented in a visual format that allows users to interactively explore the content creation process. For instance, users may be able to pause, rewind, or fast-forward the replay, or zoom in on specific parts of the content creation process. This interactive replay may provide a detailed and intuitive way for users to understand the content creation process, enhancing their ability to assess the authenticity of the digital content.

A machine learning classifier may be used to analyze the collected data and distinguish between human and AI-generated content. A machine learning classifier module implements the machine learning classifier to adapt over time to evolving patterns in content creation, enhancing its ability to accurately distinguish between human and AI-generated content. The machine learning classifier may utilize a corpus of data comparing human-generated work and human recreation of AI-generated work to train the system. This approach may allow the system to learn from past examples and improve its performance over time.

A programmatic rules-based analysis may be applied to the collected data. A programmatic rules-based analysis module implements the analysis by applying a predefined set of criteria or rules to the data. The rules may be designed to identify specific patterns or characteristics in the data that are indicative of human or AI-generated content.

A human-viewable replay of the content creation process offers a visual and interactive representation of the content creation process, allowing for a detailed examination of the interactions that occurred during the creation of the content. A human-viewable replay module implements the human-viewable replay to provide stakeholders with the ability to review the content creation process, offering a transparent and understandable means to assess the authenticity of digital works.

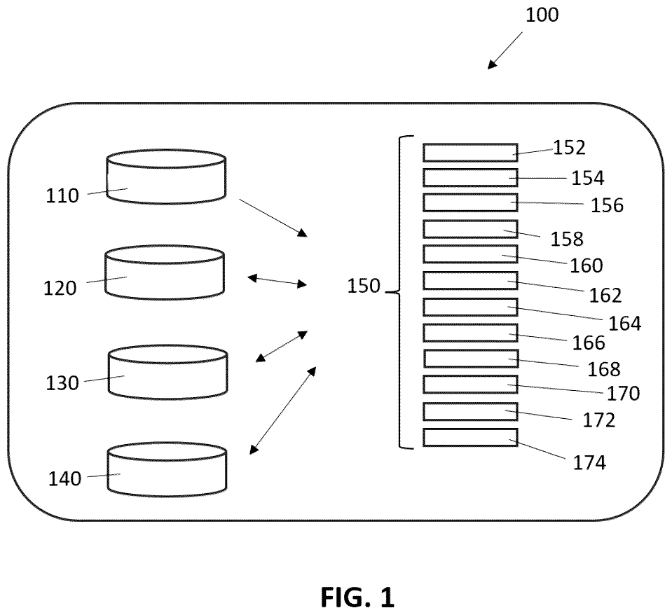

FIG. 1 shows an authentication system for analyzing digital content creation. The authentication system 100 includes collected data 150 collected by a data collection module 110, a machine learning classifier 120, a rules-based analysis module 130, and a replay module 140. The modules 110,120,130,140 work together to collect, analyze, and present a wide array of data points related to the content creation process, providing a robust and comprehensive analysis of digital content.

The authentication system includes a non-transitory computer-readable storage medium 100 storing instructions that, when executed by a processor, cause the processor to perform operations for verifying creation of digital content. The data collection module 110 collects the collected data which includes a variety of data points related to the content creation process. The keystroke dynamics data 152 collected by the data collection module 120 includes data on the timing, rhythm, and pressure of the keystrokes. The keystroke dynamics data may reflect the distinctive human typing patterns, which often differ from the uniform input often seen in AI-generated content. The syntax and style analysis data 154 collected by the data collection module 110 includes data on language use, grammar, stylistic choices, and narrative structures. The syntax and style analysis data provides insights into the nuanced human writing patterns, distinguishing them from the pattern characteristics of AI-generated content.

The machine learning classifier 120 analyzes the collected data 150 to distinguish between human and AI-generated content. The machine learning classifier 130 uses a corpus of data comparing human-generated work and human recreation of AI-generated work to train the system. The corpus of data serves as a training set for the classifier, providing examples of both human and AI-generated content. The classifier may learn from these examples, developing a model that can accurately differentiate between human and AI-generated content. Over time, as more data is collected and analyzed, the classifier may adapt and refine its model, improving its ability to distinguish between human and AI-generated content.

The rules-based analysis module 130 applies a predefined set of criteria to the collected data. In some cases, these criteria or rules may be designed to identify specific patterns or characteristics in the data that are indicative of human or AI-generated content. The application of these rules to the collected data may provide a transparent and understandable layer of analysis, complementing the machine learning classifier's analysis.

The replay module 140 may be configured to provide a human-viewable replay of the content creation process. In some aspects, this replay may offer a visual and interactive representation of the content creation process, allowing for a detailed examination of the interactions that occurred during the creation of the content. This feature may provide stakeholders with the ability to review the content creation process, offering a transparent and understandable means to assess the authenticity of digital works.

The machine learning classifier module 120, programmatic rules-based analysis module 130, and a human-viewable replay module 140 collectively analyze a wide array of data points 150 related to the content creation process. Keystroke dynamics 152 provide timing, rhythm, and pressure of key presses, reflecting unique human typing patterns versus the uniform input often seen in AI-generated content. Syntax and style analysis 154 provides examination of language use, grammar, stylistic choices, and narrative structures, distinguishing nuanced human writing from AI patterns. Error patterns and corrections 156 provide tracking the occurrence, type, and correction of errors, indicative of the iterative and sometimes imperfect human creative process. Content revision history 158 provides analysis of changes and edits over time, providing insight into the human thought process and decision-making in content creation. Behavioral data analysis 60 includes mouse movements, scrolling patterns, and navigation behaviors during the research and drafting phases, indicative of human interaction. Content creation timeline 162 provides evaluation of the pacing and distribution of content creation activities, characteristic of the varied intensity of human engagement. Gestures and touch interactions 164 provide analysis of touch screen gestures, such as swipes, taps, and zooms, which can reflect the direct and intuitive interaction of a human user. Brushstrokes and drawing pattern analysis 166 is analyzed for graphical content the analysis of brushstroke speed, pressure, and sequence, offering insights into the artist's method and style, distinguishing between human artistry and AI generation. Voice and audio analysis 168 provides for content created through voice inputs, examining pitch variations, hesitations, and natural speech patterns, contrasted with the more consistent output of speech generation AI. Physical interaction with devices 170 provides monitoring of hardware interactions, such as tablet pen usage, keyboard shortcuts, and other device-specific inputs, revealing the hands-on approach of human creators. Eye tracking and gaze patterns 172 when available, provides analysis where and how long a creator looks at specific parts of the screen during the creation process, indicating focus areas and thought progression. Biometric data 174 where applicable and ethical provides data on heart rate, body language, or facial expressions during creation, which may offer additional context about the creator's emotional state and engagement.

Each of these data points contributes to a robust analysis of digital content, allowing for an accurate determination of its origin. The machine learning classifier uses the collected data to train models that can distinguish between human and AI-generated content, adapting over time to evolving patterns. A corpus of data comparing human-generated work and human recreation of AI-generated work is used to train the system to correctly differentiate between the two. Programmatic rules-based analysis applies a predefined set of criteria to analyze content creation data, providing a transparent and understandable layer of analysis. Human-viewable replay offers stakeholders the ability to review the content creation process, providing a visual and interactive means to assess the authenticity of digital works.

In timing analysis rules may examine the time intervals between keystrokes or content creation events. For example, a rule might flag content as potentially AI-generated if the timing between keystrokes is too consistent or if large amounts of text appear instantaneously. For analyzing error and correction patterns rules may analyze the frequency and nature of errors and corrections made during content creation. Human-generated content may typically include more varied error patterns and correction behaviors compared to AI-generated content. For analyzing style consistency rules may evaluate the consistency of writing style throughout the content. Sudden shifts in style or vocabulary usage may be flagged for further investigation. In content structure analysis rules may examine the overall structure of the content, including paragraph length, sentence complexity, and the use of transitional phrases. These structural elements may differ between human and AI-generated content. For analyzing research patterns rules may analyze how information is gathered and incorporated into the content. For instance, a rule might examine the time spent on research activities versus writing activities.

In some implementations, each rule in the programmatic rules-based analysis component may be assigned a weight or importance factor. The system may use these weights to calculate an overall score or assessment based on the outcomes of individual rules. The programmatic rules-based analysis module provides several advantages in content verification including transparency, customizability, deterministic outcomes and complementary analysis. Unlike the potentially complex decision-making processes of machine learning models, rules-based analysis may be more easily understood and explained to users or stakeholders. Rules may be added, removed, or modified based on specific requirements or evolving understanding of content creation patterns. Given the same input, the rules-based analysis may always produce the same result, which may be beneficial in certain applications where consistency is crucial. The rules-based component may provide a different perspective on content authenticity, potentially catching patterns or anomalies that the machine learning classifier might fail to identify.

The authentication system is used in a method of monitoring a wide variety of interactions while a human is inputting them to ensure that they are not copying from AI-generated content or other plagiarized material, and authentically creating it themselves. The method uses a corpus of data of authentic and ai-copying creation in order to train a machine learning classifier, as well as using rules-based classification and human analysis of replays of the process.

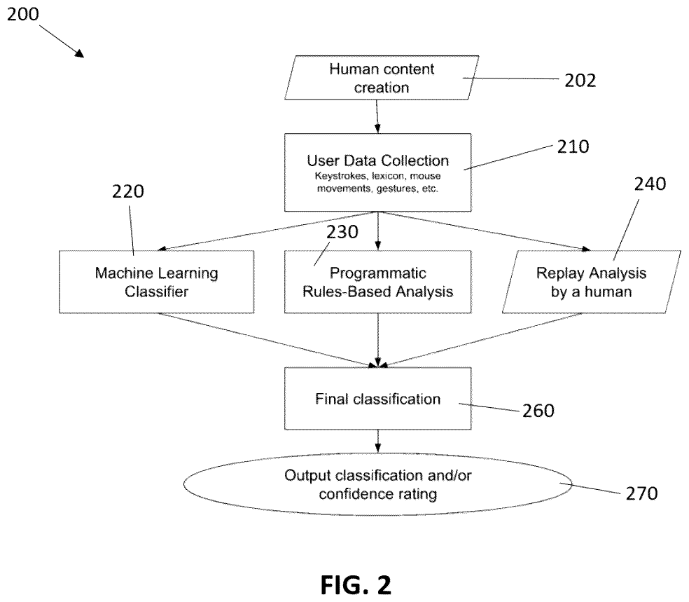

FIG. 2 is a flowchart 200 showing how the authentication system analyzes human content and creates output classification and/or confidence rating. The authentication system analyzes the human content creation 202 and user data collection 210 also referred to as collected data. Keystrokes, lexicon, mouse movements, gestures and other manual or electronic functions or motions are part of the user data collection 210 and processed through a machine learning classifier module 220, a programmatic rules-based analysis module 230 and a replay analysis module 240. The information from these modules is transferred to a final classification module that outputs the classification and/or confidence rating.

The method of using the authentication system for analyzing digital content creation includes collecting a variety of data points related to the content creation process and using a machine learning classifier to analyze the collected data and distinguish between human and AI-generated content. The method includes applying a programmatic rules-based analysis to the collected data and providing a human-viewable replay of the content creation process.

The authentication system uses adaptive learning techniques to continuously improve its ability to distinguish between AI and human-generated content. As new examples of both AI and human-generated content become available, the system may update its analysis models to account for evolving patterns and characteristics. This ongoing refinement may help reduce false positives over time as the system becomes more adept at recognizing the nuanced differences between AI and human outputs.

In some embodiments the systems or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. The system can also collect the GPS location information of the user and couple it with the user data collection to verify the user. This allows the system to look at the user and categorize the user and their respective attributes collected. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An authentication system for verifying creation of digital content, comprising:
a data collection module for collecting a variety of data points related to a content creation process;
a machine learning classifier module for analyzing data points related to the content creation process;
a programmatic rules-based analysis module for applying predefined criteria to the data points; and
a human-viewable replay module for providing a visual representation of the content creation process,
wherein the authentication system for determining whether the digital content was created by a human or generated by artificial intelligence based on outputs from the machine learning classifier, the programmatic rules-based analysis module, and the human-viewable replay module.

2. The authentication system of claim 1 wherein the data points include one or more of keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data.

3. The authentication system of claim 1 wherein the authentication system provides a confidence score indicating a likelihood that the digital content was created by a human, the confidence score expressed as a percentage.

4. The authentication system of claim 3 wherein the confidence score is based on outputs from the machine learning classifier and the programmatic rules-based analysis module.

5. The authentication system of claim 1 wherein the authentication system reduces false positives in identifying AI-generated content by analyzing depth and complexity of the content creation process.

6. The authentication system of claim 1 wherein the authentication system is adaptable and scalable to various types of digital content including text, images, audio, and video.

7. The authentication system of claim 6 wherein the authentication system is configured to evolve alongside advancements in AI technology by updating analysis techniques, data points, and machine learning models.

8. A method for verifying creation of digital content, comprising:
collecting data points related to a content creation process;
analyzing the collected data points using a machine learning classifier;
applying programmatic rules-based analysis to the collected data points;
providing a human-viewable replay of the content creation process; and
determining, based on the analyzing, the applying, and the human-viewable replay, whether the digital content was created by a human or generated by artificial intelligence.

9. The method of claim 8 wherein the data points include one or more of keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data.

10. The method of claim 8 including providing a confidence score indicating a likelihood that the digital content was created by a human, wherein the confidence score is expressed as a percentage.

11. The method of claim 10 wherein the confidence score is based on outputs from the machine learning classifier and the programmatic rules-based analysis.

12. The method of claim 8 including reducing false positives in identifying AI-generated content by analyzing depth and complexity of the content creation process.

13. The method of claim 8 wherein the method is adaptable and scalable to various types of digital content including text, images, audio, and video.

14. The method of claim 13 including evolving the method alongside advancements in AI technology by updating analysis techniques, data points, and machine learning models.

15. A non-transitory computer-readable storage medium storing instructions that, when executed by a processor, cause the processor to perform operations for verifying creation of digital content, the operations comprising:
providing a authentication system for verifying creation of digital content, the authentication system including a machine learning classifier; a programmatic rules-based analysis module for applying predefined criteria to data points; and a human-viewable replay module for providing a visual representation of the content creation process, wherein the authentication system determines whether the digital content was created by a human or generated by artificial intelligence based on outputs from the machine learning classifier, the programmatic rules-based analysis module, and the human-viewable replay module receiving data points related to a content creation process;
processing the data points using a machine learning classifier and a programmatic rules-based analysis module;
generating a human-viewable replay of the content creation process; and
determining a likelihood that the digital content was created by a human based on outputs from the machine learning classifier, the programmatic rules-based analysis module, and the human-viewable replay.

16. The non-transitory computer-readable storage medium of claim 15 wherein the data points include one or more of keystroke dynamics, syntax and style analysis, error patterns and corrections, content revision history, behavioral data, content creation timeline, gestures and touch interactions, brushstrokes and drawing patterns, voice and audio analysis, physical interaction with devices, eye tracking and gaze patterns, and biometric data.

17. The non-transitory computer-readable storage medium of claim 15 wherein the operations include providing a confidence score indicating a likelihood that the digital content was created by a human, wherein the confidence score is expressed as a percentage.

18. The non-transitory computer-readable storage medium of claim 17 wherein the confidence score is based on outputs from the machine learning classifier and the programmatic rules-based analysis module.

19. The non-transitory computer-readable storage medium of claim 15 wherein the operations include reducing false positives in identifying AI-generated content by analyzing depth and complexity of the content creation process.

20. The non-transitory computer-readable storage medium of claim 15 wherein the operations are adaptable and scalable to various types of digital content including text, images, audio, and video, and wherein the operations include evolving alongside advancements in AI technology by updating analysis techniques, data points, and machine learning models.
